(19) United States
(12) Patent Application Publication
(10) Pub. No.: US 2005/0091904 A1
(43) Pub. Date: May 5, 2005

(54) A swimming wildfowl decoy driven by a through the keel, water jet propulsion system.

(75) Inventor: Barry Alan Sullivan, Tallulah, LA (US)

Correspondence Address: BARRY ALAN SULLIVAN, 1933 THOMASTOWN ROAD, TALLULAH, LA, 71282, US

(73) Assignee: Barry Alan Sullivan, Tallulah, LA (US)

(21) Appl. No.: 10/605,898

(22) Filed: Nov. 5, 2003

(51) Int. Cl. A01M 31/06

(52) U.S. Cl. 43/3

(57) ABSTRACT

A motorized wildfowl decoy designed to mimic the random, back and forth, swimming actions of live waterfowl utilizing a through the keel, water jet propulsion system, and an anchor system. The propulsion pump, powered by a rechargeable battery, is located on the underside, in a cut out section of the water keel, near the front of the decoy body, with the discharge being routed through the water keel, then directed towards the water surface though a 45 degree bend, at the aft of the water keel, and out through a swim course correction orifice which is a rotatable cap on the end of the discharge tubing with an off-centered discharge hole. The propulsion system, combined with the anchor system, produces a random straight line then turn/change course, straight line then turn/change course action similar to the swimming actions live waterfowl use while feeding.

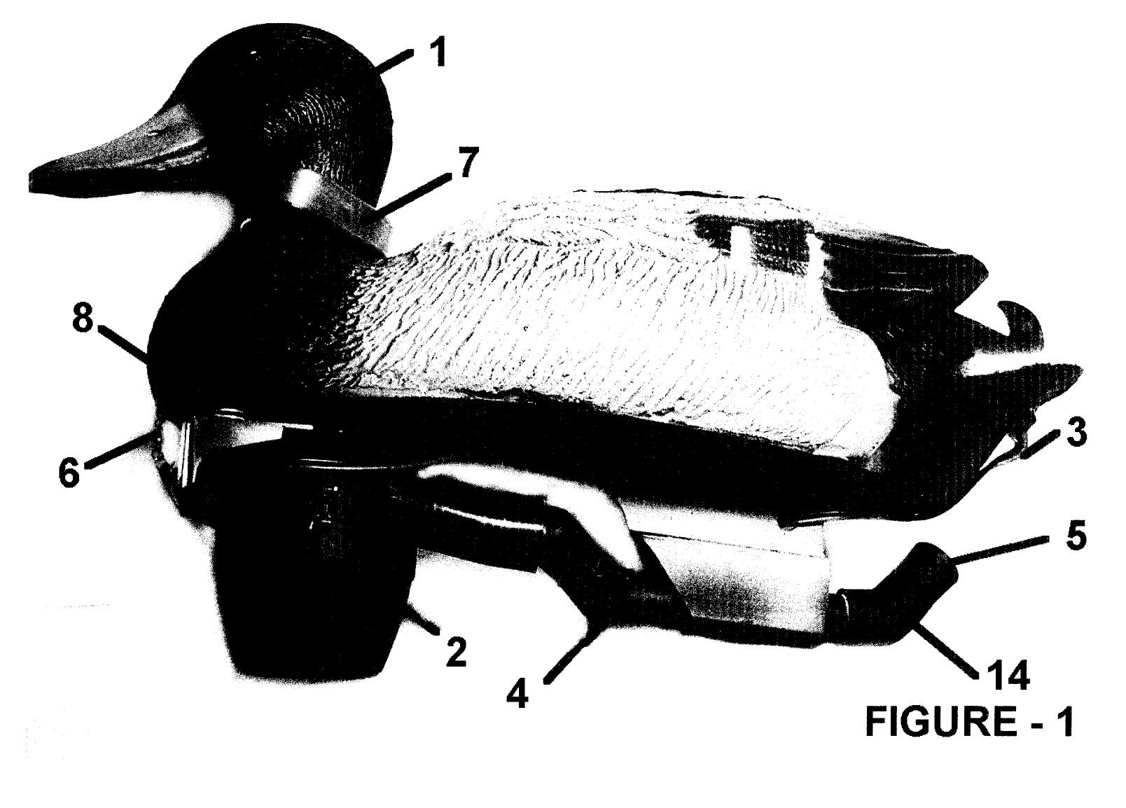

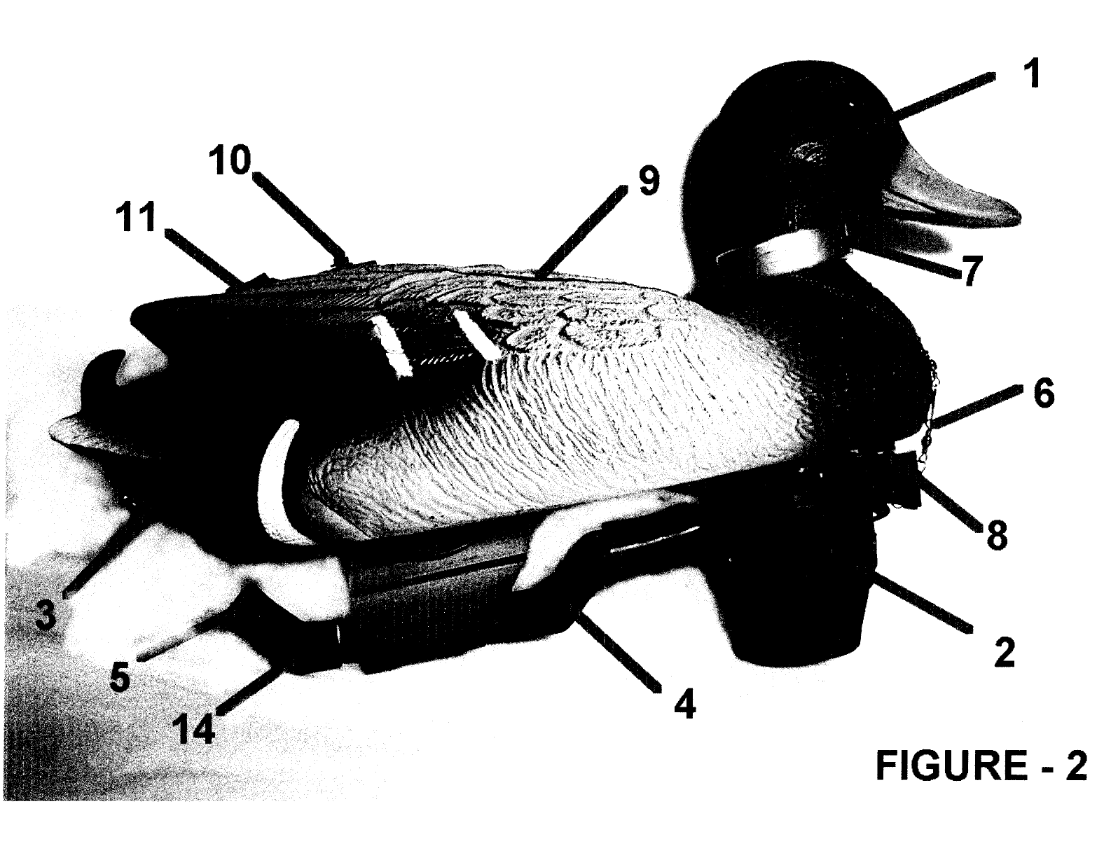

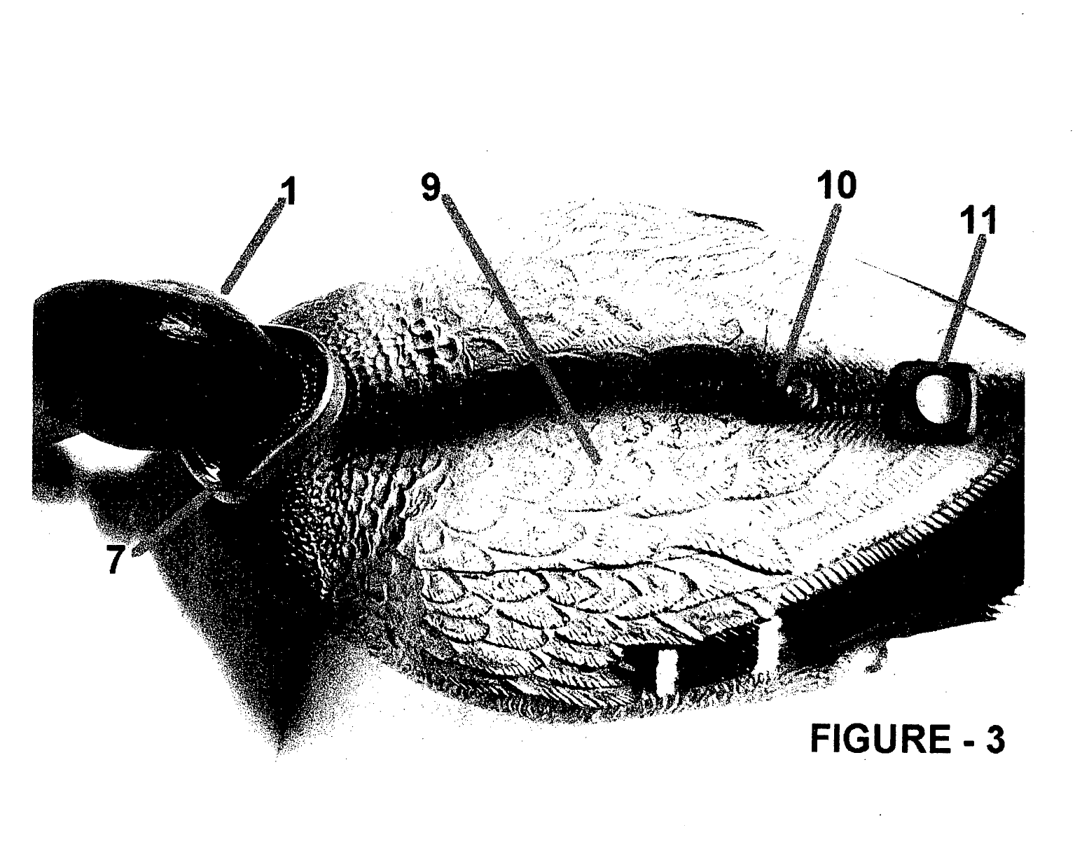

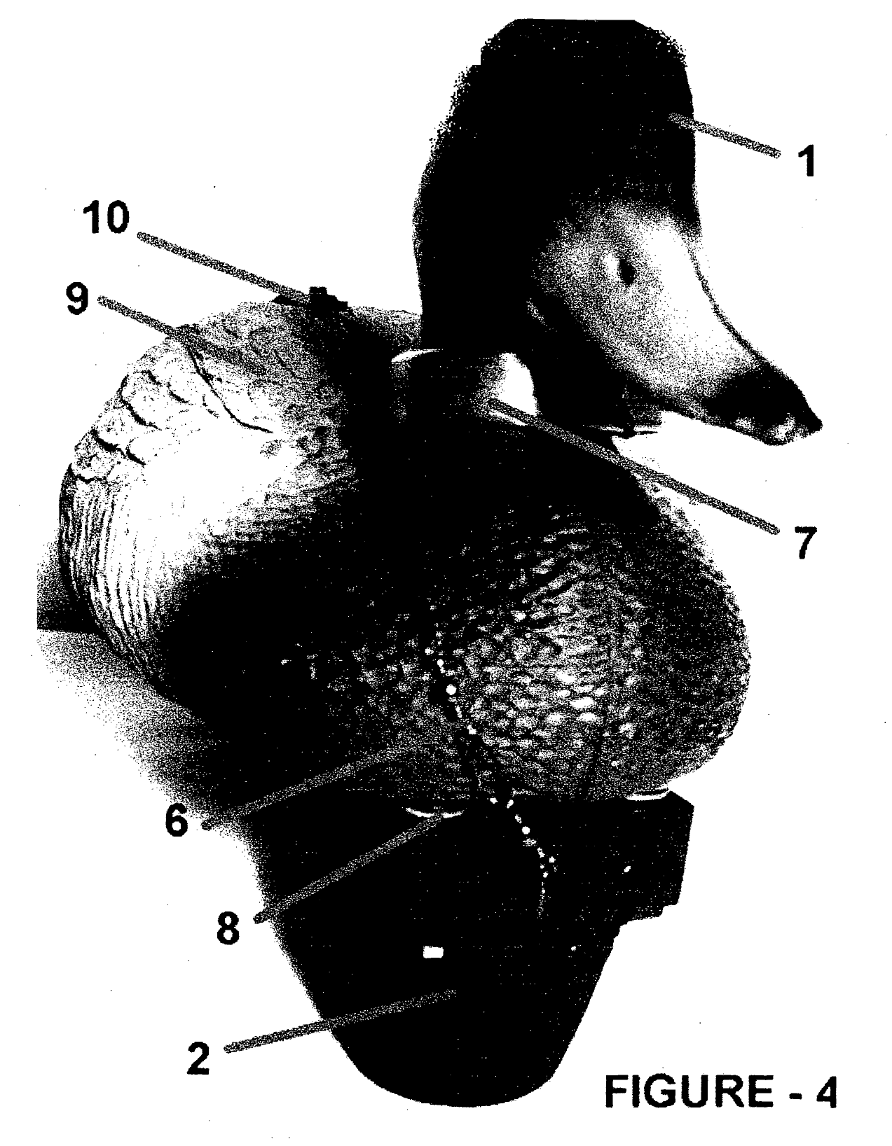

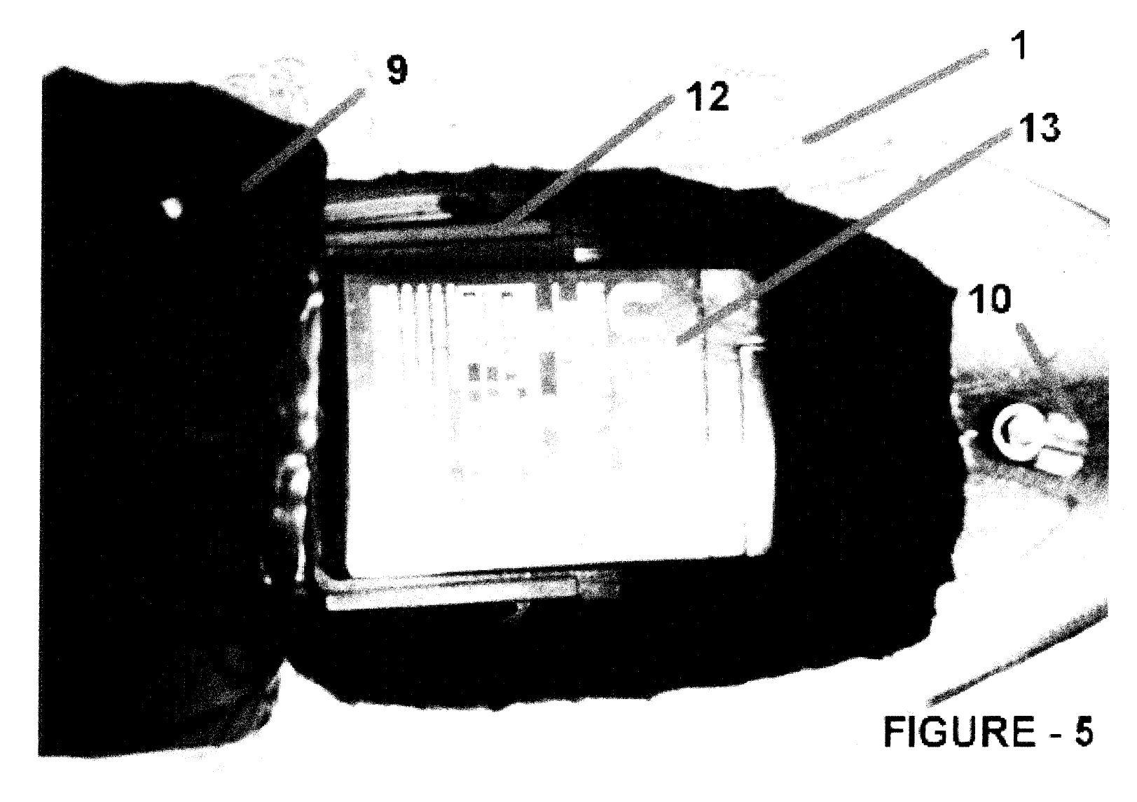

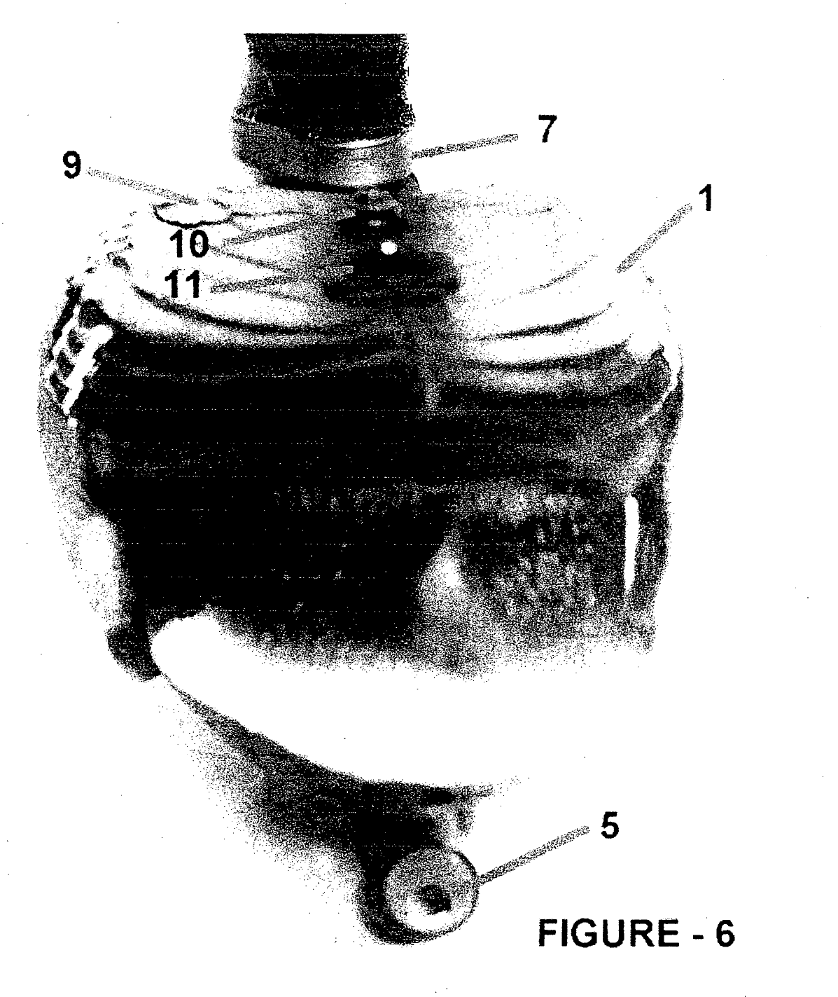

A swimming wildfowl decoy driven by a through the keel, waterjet propulsion system.

### DETAILED DESCRIPTION OF THE INVENTION

A motorized wildfowl decoy which is designed to closely mimic the random, back and forth swimming actions of live waterfowl utilizing a through the keel, water jet propulsion system, and an anchor system. The propulsion system is located on the under side of the decoy and incorporated into the existing water keel of the decoy. The propulsion pump, powered by a rechargeable battery, is located in a cut out section of the water keel near the front of the decoy body, with the propulsion discharge being routed through the water keel, then being directed towards the water surface though a 45 degree bend, located at the aft of the water keel, and out through a swim course correction orifice which is a rotatable cap on the end of the discharge tubing with an off-centered discharge hole. The purpose for directing the discharge toward the water surface is to create a lifelike wake behind the decoy as it swims through the water. The swim course correction orifice can be rotated clockwise or counter-clockwise to adjust the swim pattern. The anchor system consists of a conventional lead decoy anchor with a line, attached by a swivel, to the center of the bottom of the front of the decoy's water keel and of sufficient length, based on water depth, and to yield the desired field of swimming pattern. The propulsion system is designed to give a relatively straight line swimming pattern, which combined with the anchor system, produces a random straight line then turn/change course, straight line then turn/change course action similar to the swimming actions live waterfowl use while in a feeding area. This swim pattern is not achieved by any other motorized decoy

1) A swimming wildfowl decoy which utilizes a waterfowl decoy body, a through the keel water jet propulsion system, a rechargeable power source, and weighted/swiveled anchor line designed to operate as a complete system which will closely mimic the random, back and forth, swimming actions of live waterfowl in their natural habitat.

2) A swimming wildfowl decoy according to claim 1, wherein a section of the water keel is removed to provide the space required to mount the propulsion pump to the decoy body.

3) A swimming wildfowl decoy according to claim 1, wherein the propulsion pump base is fixed securely to the decoy using mounting hardware and waterproof seals.

4) A swimming wildfowl decoy according to claim 1, wherein the propulsion pump is attached in such a manner as to be removed from its base, without the use of tools, to facilitate inspection, cleaning, or minor maintenance.

5) A swimming wildfowl decoy according to claim 1, wherein the propulsion pump discharge is routed through the water keel of the waterfowl decoy and exits the aft section of the water keel, is directed toward the water surface through an angular fitting, and exits through a swim course correction orifice. The orifice shall be equipped with an off-center discharge hole to provide for simple direction change through counterclockwise and/or clockwise rotation in order to accomplish the desired straight line then turn, straight line then turn swimming pattern similar to that of live waterfowl.

6) A swimming wildfowl decoy according to claim 1, wherein the propulsion pump wiring is routed from the pump into the decoy body above the normal draft line and sealed to prevent leakage into the decoy body.

7) A swimming wildfowl decoy according to claim 1, wherein an on/off switch is mounted into the decoy body well above the normal draft line.

8) A swimming wildfowl decoy according to claim 1, wherein a hatch is cut in the top of the decoy's back to create access to the inside of the decoy body for both initial assembly and for battery insertion and removal. The hatch is held closed by a turn button latch.

9) A swimming wildfowl decoy according to claim 1, wherein a battery positioning tray is securely attached to the interior floor of the decoy body and placed in the proper position to ensure balance during operation and to facilitate ease of battery installation and removal.

10) A swimming wildfowl decoy according to claim 1, wherein a sealed lead acid, rechargeable battery is secured, during operation, by adhesive backed, industrial hook and loop fastening material attached to both the battery and the battery tray.

11) A swimming wildfowl decoy according to claim 1, wherein an anchor of appropriate weight is attached to the center of the bottom of the front of the decoy's water keel utilizing a line of sufficient length, based on water depth, to provide a random, back and forth swimming pattern, not a circular pattern, within the limits set by string length.

12) A swimming wildfowl decoy according to claim 1, that is self propelled and swims in a straight line then turn, straight line then turn swimming pattern similar to that of live waterfowl.
